(19) United States
(12) Patent Application Publication
(10) Pub. No.: US 2013/0009963 A1
(43) Pub. Date: Jan. 10, 2013

(54) GRAPHICAL DISPLAY OF DATA WITH ANIMATION

(75) Inventor: Brian Albrecht, Kirkland, WA (US)

(73) Assignee: MICROSOFT CORPORATION, Redmond, WA (US)

(21) Appl. No.: 13/178,457

(22) Filed: Jul. 7, 2011

(51) Int. Cl. G06T 13/00

(52) U.S. Cl. 345/473

(57) ABSTRACT

An animated graphic transition is displayed to represent a data difference between data sets. A plurality of data sets is provided, and a user is presented with a plurality of options that includes selection of one or more data sets. A user selection from the plurality of options is detected. Displayed are a first graphic element that represents data in one data set and a second graphic element that represents data in another data set. An animated graphic transition is displayed in conjunction with the first and second graphic elements to represent a data difference between the selected data sets.

### BACKGROUND

Presentation and comparison of different data groups through a software application is a common experience for computer users. For example, a user may have data series for multiple time periods, such as monthly sales figures per year for multiple years. A user may chart such data series together for comparison, e.g., a chart may show sales figures by month for one year in one color, sales figures by month for another year in a different color, and so on. When comparing just two years of such data, it may be difficult to see the changes, for example, year over year sales increasing in some months and decreasing in other months. It may become even more difficult to see the changes as more data groups are added, e.g., such a chart including sales figures by month for three or more years.

Thus, a user wishing to understand and compare different data groups may have to study and contemplate the data groups and charts thereof for some time, increasing the time and effort for the user. Further, once the user arrives at some understanding of the different data groups, the user may find it challenging to transmit this understanding to others. For example, in presenting the data groups at a meeting, the user may not have time for the audience to also study and contemplate the data groups, so the user may be led to create an abbreviated explanation, which may not lead to the same level of understanding in the audience. The present disclosure appreciates that it may be difficult to see the relationships between different data groups, e.g., how the data changes from one data group to the next.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to graphically displaying data. A plurality of data sets may be provided, and a user may be presented with options for selection. The options may include selection of one or more data sets from the plurality of data sets. Upon detecting user selection, a plurality of graphic elements may be displayed, which may include a first graphic element that represents data in a first data set and a second graphic element that represents data in a second data set. An animated graphic transition may be displayed in conjunction with the first and second graphic elements to present a data difference between the first and second data sets.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes conceptual diagrams illustrating a local and networked configuration environment, where embodiments may be implemented;

FIG. 2 illustrates screenshots of an example user interface for selecting data sets according to embodiments;

FIG. 3 illustrates further screenshots that include displaying graphic elements associated with data sets, according to embodiments;

FIG. 4 illustrates screenshots that include displaying an animated graphic transition in conjunction with the graphic elements to represent a data difference between the data sets according to embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of graphically displaying data-according to embodiments.

### DETAILED DESCRIPTION

As briefly described above, in graphically displaying data, a plurality of data sets may be provided, and a user may be enabled one or more of the data sets. The data sets may then be graphically presented in an animated fashion that emphasizes changes from one data set to the other employing various schemes.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held computing devices such as smart phones, multiprocessor systems, microprocessor-based or programmable consumer electronics such as tablet PCs or special purpose devices, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for graphically displaying data. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

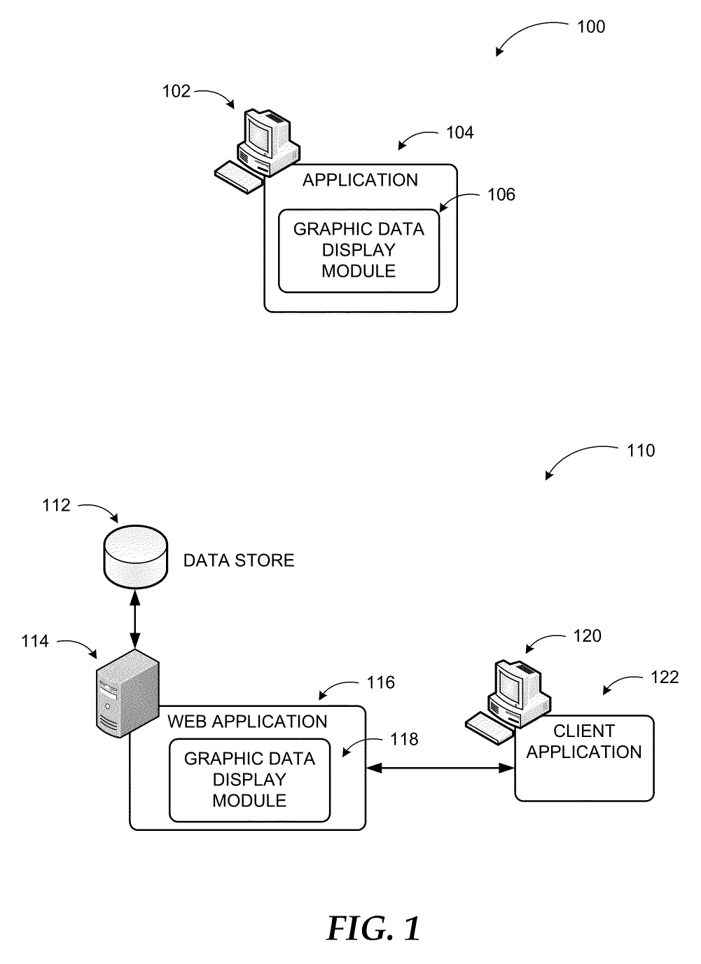

Referring to FIG. 1, conceptual diagrams 100 and 110 illustrate a local and networked configuration environment, where embodiments may be implemented. The computing devices and computing environments shown in diagram 100 are for illustration purposes. Embodiments may be implemented in various local, networked, and similar computing environments employing a variety of computing devices and systems.

Diagram 100 represents local computing environment in computing device 102, where an application 104 may enable a user to graphically display data, including an animated graphic transition that may be displayed in conjunction with different graphic elements to represent a data difference, through graphic data display module 106. Computing device 102 may be any computing device including, but not limited to, desktop computers, laptop computers, servers, handheld computers, vehicle mount computers, smart phones, and comparable devices.

Application 104 may be any application capable of graphically displaying data, such as a spreadsheet, a presentation program, a charting program, a web browser for running an interactive chart on a web page, a plotting applet, or the like. For example, graphically displaying data may include creating and displaying a graph, chart, plot, or other presentation. Graphically displaying data may also include selecting or manipulating data in numeric or symbolic form, selecting options for graphically displaying data, and so on. Graphically displaying data is not limited to application 104. Application 104 may enable graphically displaying data using data from another application or device, or controlling another application or device to graphically display data.

Graphic data display module 106 may perform operations associated with graphically displaying data, including providing a plurality of data sets; presenting a plurality of options for selection by a user, including selection of one or more data sets from the plurality of data sets; detecting a user selection from the plurality of options; displaying a plurality of graphic elements representing data in the selected data sets; and displaying one or more animated graphic transitions in conjunction with presenting the graphic elements to represent a data difference between the selected data sets.

Graphic data display module 106 may be a separate application or an integrated part of application 104. Application 104 and/or graphic data display module 106 may control a user interface and provide suitable visual elements for the user to see information associated with available options, make selections, etc.

Diagram 110 illustrates a networked configuration environment. In the example environment, the graphic data display is provided by web application 116 and its graphic data display module 118 executed on server 114. Server 114 may store and retrieve data associated with the plurality of data sets using data store 112. A user may interact with web application 116 through their client application 122 (e.g. a browsing application) executed on computing device 120. Web application 116 and graphic data display module 118 may operate as discussed above. The networked environment may include communications between computing device 120 and server 114 over one or more networks, which may include enterprise networks, cloud-based networks, combinations of those two, and similar ones.

The example systems in FIG. 1 have been described with specific servers, client devices, applications, modules, and interactions. Embodiments are not limited to systems according to these example configurations. A platform providing graphic display of data, including an animated graphic transition that may be displayed in conjunction with first and second graphic elements to represent a data difference, may be implemented in configurations employing fewer or additional components and performing other tasks. Furthermore, specific protocols and/or interfaces may be implemented in a similar manner using the principles described herein.

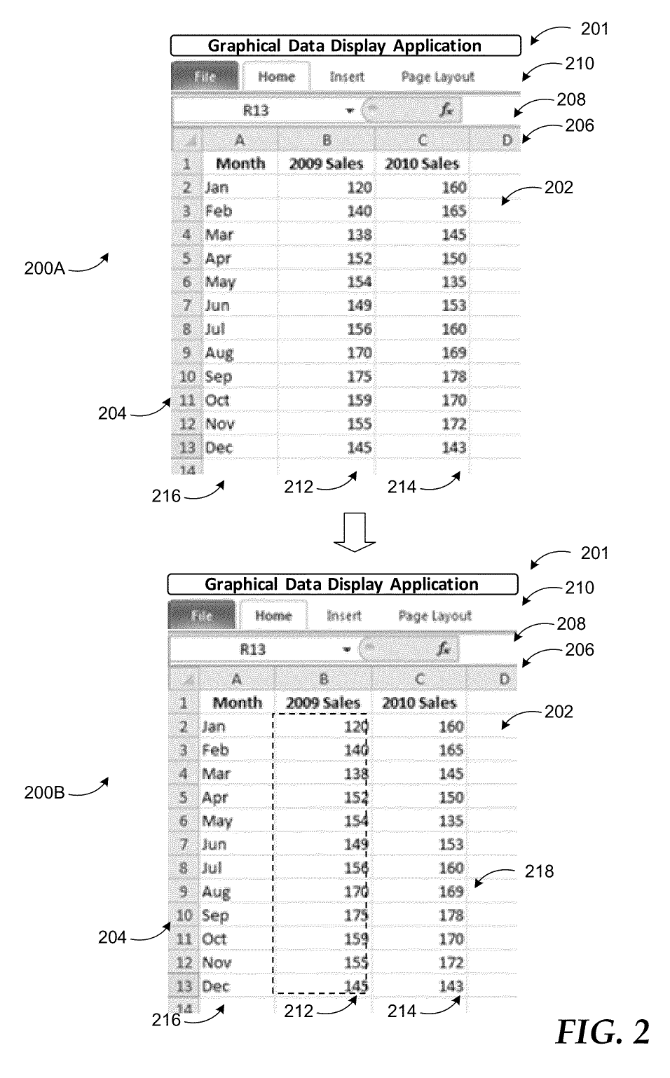

FIG. 2 illustrates screenshots 200A and 200B of an example spreadsheet application user interface 201 for graphically displaying data, including an animated graphic transition that may be displayed in conjunction with first and second graphic elements to represent a data difference, as described herein. Embodiments may be implemented through any application capable of providing graphic data display, such as a spreadsheet, a presentation program, a charting program, a web browser for running an interactive chart on a web page, a plotting applet, or the like. The example spreadsheet application user interfaces shown in screenshot 200A and 200B are for illustration purposes only. The example spreadsheet application user interfaces include standard elements such as data cells 202 which may include quantitative numerical or textual data, numerical or textual labels, and so on; row indices 204 for the data cells; column indices 206 for the data cells; an entry bar 208 for entering data, formulae, and the like; command menus 210; and so on.

Screenshot 200A illustrates the example spreadsheet application user interface 201 with a first data set 212 “2009 Sales” in column B and a second data set 214 “2010 Sales” in column C. Thus, example spreadsheet application user interface 201 provides a plurality of data sets 212 and 214.

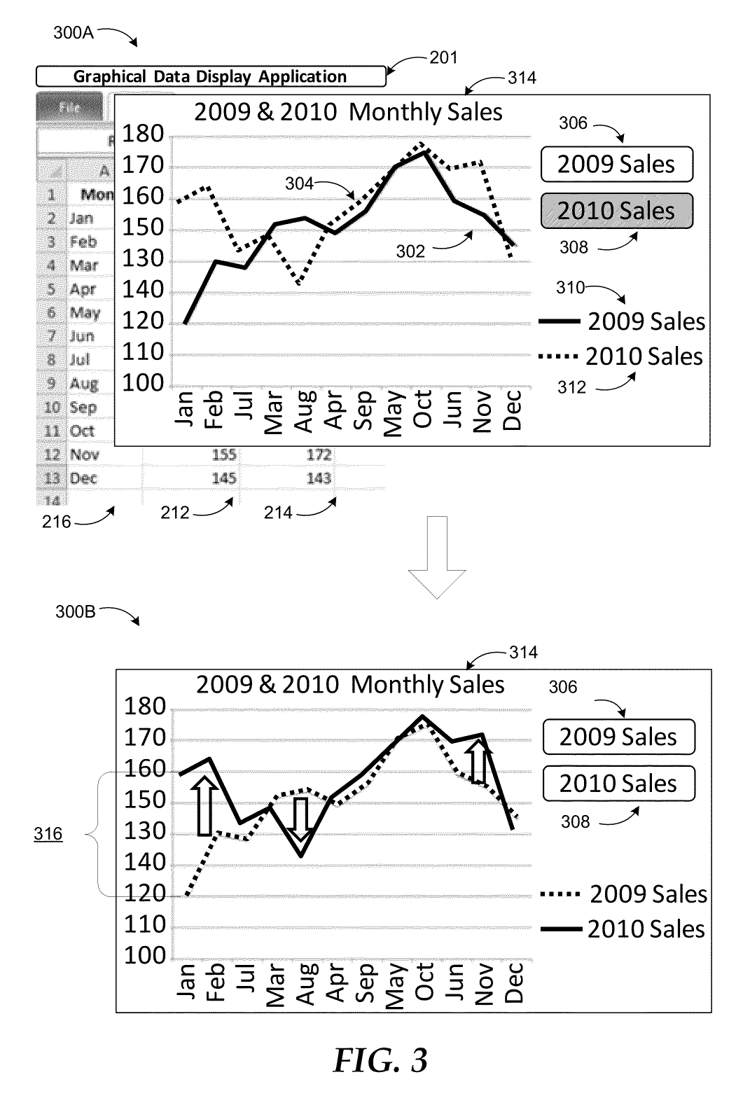

The plurality of data sets may be provided, e.g., by user entry of data into a spreadsheet or database; by accessing data stored locally or in a network in a spreadsheet, database, text file, or other data storage format; by selecting a data feed, e.g., from a scientific instrument, a news service, a stock market data service; or the like. A data set may include at least one series of two or more quantitative, e.g., numerical, data points, for example, a list of prices. A data set may include an implied or explicit index of time or other data, for example, a data set may include a series of twelve prices which imply monthly prices for a year, or the data set may include the series of twelve prices and may also explicitly include a series of the twelve months corresponding to the twelve prices. In the example shown in FIG. 2 and FIG. 3, the twelve data points in each data set are monthly sales figures, each associated with a corresponding month index 216 (column A).

Screenshot 200B shows that a user has dragged a selection box 218 over data set 212. In some embodiments, the user may subsequently or simultaneously select data set 214 and/or month index 216 for graphic representation. Thus, example spreadsheet application user interface 201 presents a plurality of options for selection by a user, including selection of a first data set 212 and a second data set 214 from the plurality of data sets. Moreover, example spreadsheet application user interface 201 detects the user's selection 218 from the plurality of options, in this example, first data set 212 from the plurality of data sets.

FIG. 3 illustrates screenshots 300A and 300B. Based on the user's data set selections 218 in screenshot 200B in FIG. 2, screenshot 300A in FIG. 3 shows that example spreadsheet application 201 displays a plurality of graphic elements, including a first graphic element 302 that represents data in data set 212 (in this example, “2009 Sales”) and a second graphic element 304 that represents data in data set 214 (in this example, “2010 Sales”).

The graphic elements 302 and 304 are presented in this example as line graphs of sales data versus month, where vertices in the line graphs correspond to individual data points in data sets 212 and 214. Any suitable graphic elements simple or complex may be employed for representing data in the data sets. For example, data points may be represented by text, symbols, graphic icons, bars, pie slices, vertices or inflections in connectors between data points, and so on; and data points may be connected by lines, curves, and so on. Graphic elements may themselves be a collection of individual graphic elements, such as a collection of data points corresponding to the data sets. The graphic elements may be presented with variations, such as in shade, color, fill, line weight, and so on, and may themselves be animated apart from the animated transition described herein. The graphic elements may be presented with gradients, such as in shade, color, fill, line weight, and so on that tend to give the impression of direction, motion, perspective, or the like. Such gradients may be employed to indicate the direction or magnitude of a data difference between data sets.

Referring back to screenshot 200B in FIG. 2, the user selection of the plurality of options can also be determined by any other suitable detection of user input, such as a user selection of a checkbox, a selectable link, a drop-down menu, a radio button, or one of the plurality of graphic elements that represents data in one of the plurality of data sets. Thus, the options may be selected by the user by specifying textual, numerical, or graphic identifiers that correspond to the data sets, for example, icons of data set files in a storage medium, field codes that specify the location of the data sets in a database, names of data set files stored on a hard drive, and so on. For example, referring now to screenshots 300A and 300B in FIG. 3, the user may indicate selection of data set 212 or data set 214 by selection of the corresponding graphic elements 302 or 304, or alternatively, by selecting a selectable link such as control buttons 306 or 308, respectively or legend links 310 or 312, respectively.

The user selection may be determined based on an active selection, for example, if the user actively clicks on graphic elements 302 or 304, or control buttons 306 or 308, or legend links 310 or 312. The user selection may also be determined by a pointer hovering over one of the plurality of graphic elements, for example, if the user hovers a mouse pointer over graphic elements 302 or 304, or control buttons 306 or 308, or legend links 310 or 312.

FIG. 3 also illustrates that example spreadsheet application 201 has plotted graphic elements 302 and 304 in an automatically recommended presentation 314, here a line chart. That is, FIG. 3 shows an example of example spreadsheet application 201 enabling the user to select an automatically recommended presentation for displaying the first and second graphic elements and the first animated graphic transition. Other variations may be included, e.g., enabling the user to select an existing presentation of the first and second graphic elements for displaying the first animated transition; enabling the user to select a new presentation for displaying the first and second graphic elements and the first animated graphic transition; and the like. As used herein, a presentation, such as automatically recommended presentation 314, includes any arrangement of graphic elements that may be used to represent data, for example, charts, graphs, plots, and the like.

In screenshot 300A, the user has selected data set 212 as indicated by the shading over corresponding control button 306. Screenshot 300B illustrates displaying a first animated graphic transition in conjunction with the first and second graphic elements 302 and 304 to represent a data difference between the first and second data sets 212 and 214.

The animated transition, e.g., animated transition between first and second graphic elements 302 and 304, can be any animation which tends to convey, represent, or highlight any data differences between first and second data sets 212 and 214. For example, as shown in FIG. 3, user selection of the second data set 214 in screenshot 300A leads to a change in shade of graphic elements 302 and 304 in screenshot 300B, with the arrows indicating an animated transformation of the first graphic element 302 into the second graphic element 304. Many other options are possible for the animated transition. For example, the animated transition can include a change in shade of one or more of the graphic elements, such as the change of shade shown for graphic elements 302 and 304 between screenshots 300A and 300B, or a change in color of one or more of the graphic elements, such as changing the color of graphic element 302 or 304. Furthermore, the transition may include timed appearance and disappearance of one or more intermediate graphic elements between graphic elements 302 and 304.

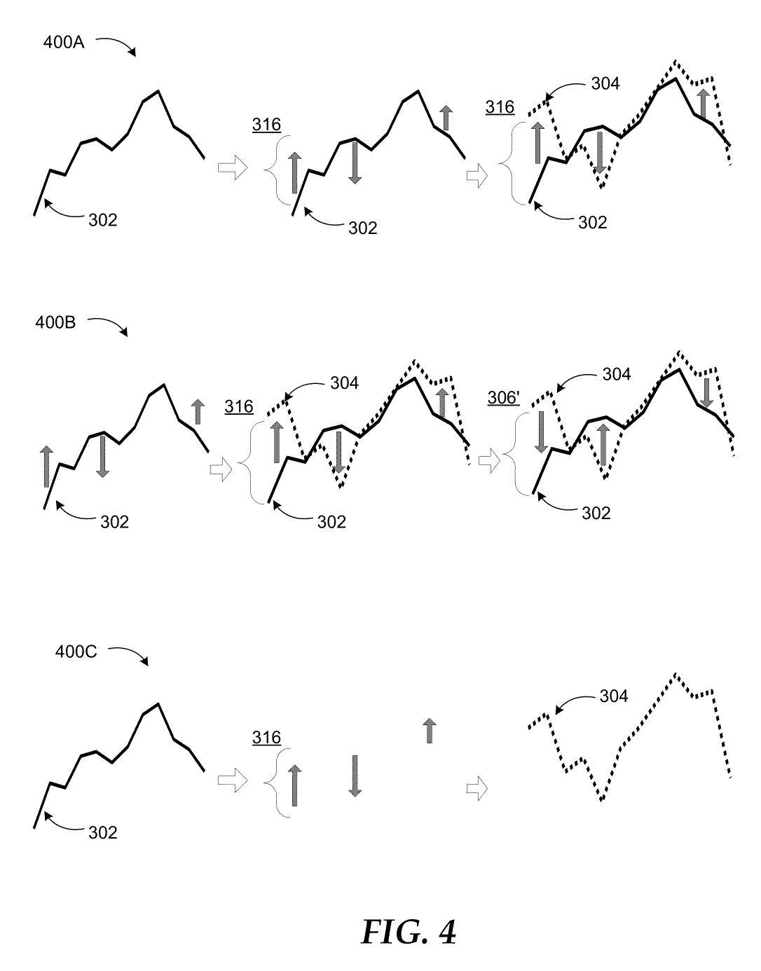

The animated transition and graphic elements, e.g., animated transition between first and second graphic elements 302 and 304 can be displayed in various sequences; repeated or cycled; hidden or displayed; emphasized or deemphasized; and so on. FIG. 4 shows some examples of sequences. For example, a first sequence 400A may include displaying the first graphic element 302, the first animated transition, and the second graphic element 304. In another example, a second sequence 400B may include displaying the first graphic element 302, the first animated transition, the second graphic element 304, and a reversed sequence of the first animated transition. As used herein, a “reversed sequence” means that the animated transition is animated in reverse; for example, animated transition may be played in a sequence that represents the data difference in moving from graphic element 302 to graphic element 304, and a corresponding reverse sequence may include playing animated transition to represent the data difference in moving from graphic element 304 to graphic element 302. Sequences such as the preceding first and second sequences may be repeatedly displayed, e.g., in a loop. The plurality of options may include one or more parameters for automatically repeating displaying the animated transition; suitable parameters include, for example, the direction of play, e.g. continuously forward, or forward and reverse sequence; the number of times to repeat displaying the animated transition; the speed of playing the animated transition; and the like.

Screenshots 300A and 300B in FIG. 3 are intended to convey an example where graphic elements 302 and 304 are displayed continuously during animated transition between screenshots 300A and 300B. In other examples, the graphic elements and the animated transition may be alternately displayed or hidden, or displayed or hidden in various sequences, or the like. Some examples include displaying one or more of the graphic elements prior to displaying the first animated transition; for example, as shown in FIG. 3, first and second graphic elements 302 and 304 may be displayed in screenshot 300A before displaying animated transition in screenshot 300B. Other example sequences shown in FIG. 4 include displaying the first graphic element and the first graphic transition prior to displaying the second graphic element, e.g., as in sequence 400A; displaying the first animated transition and hiding one or more of the graphic elements, e.g., as in sequence 400C; and displaying the first animated transition and changing the color or shade of one or more of the graphic elements.

Screenshots 300A and 300B in FIG. 3 are also intended to convey an example where animated transition between graphic elements 302 and 304 in screenshots 300A and 300B represents a transformation of graphic element 302 into graphic element 304. In other examples, the animated transition may include one or more graphic elements that extend between the first and second graphic elements, for example, filling the space between with a color or shade. Such a filling animation may include a different color or shade depending on the direction of the change between the data sets; for example, a decrease in value may be represented by a first color and an increase may be represented by a second color.

In some example embodiments, elements such as arrows shown in screenshots 300A and 300B may convey the direction of animated graphic transition. Other graphic elements may also be displayed that represent a direction of the data difference between the first and second graphic elements. The direction of the data difference may be represented with a symbolic directional indicator, for example: with arrows or lines; or textually, e.g., with plus or minus signs. The direction of the data difference may be represented graphically, e.g., with a change in color, shade, or perspective, such as a color gradient, shade gradient, or perspective gradient; or spatially, e.g., with leading or trailing indicators such as arrows or lines; or the like. For example, arrows such as those shown for the purpose of illustrating FIG. 3 may be included as part of the animated transition. In another example, the animated transition may include a color or shade fill between the graphic elements, where a first color or shade indicates an increase in data value between the data sets and a second color or shade indicates a decrease in data value between the data sets. In another example, the animated transition may include a perspective gradient that conveys the impression of an elevation or peak to indicate an increase in data value between the data sets and a perspective gradient that conveys the impression of a depression or valley to indicate a decrease in data value between the data sets.

The examples shown in FIG. 2 through FIG. 4 are described by way of example with two data sets in the plurality of data sets. In further examples, one or more additional data sets and one or more additional graphic elements may be employed, and so on. In one further example, a third data set and a fourth data set are determined from the user selection of the plurality of options; a third graphic element and a fourth graphic element are displayed that represent data in the third and fourth data sets; and a second animated transition is displayed, wherein the second animated graphic transition is displayed in conjunction with the third and fourth graphic elements to represent a data difference between the third and fourth data sets. The one or more additional data sets and one or more additional graphic elements may be employed with reference to each other or with reference to the first or second data sets. In yet another example, the third data set may be different from the second data set, and the fourth data set may be automatically determined to be the second data set or selected by the user from the plurality of data sets.

The examples in FIG. 2 through FIG. 4 have been described with specific user interface elements, data sets, graphic elements, animated transitions, and presentations. Embodiments are not limited to systems according to these example configurations. The graphic display of data described herein may be implemented in configurations using other types of user interface elements, data sets, graphic elements, animated transitions, and presentations in a similar manner using the principles described herein.

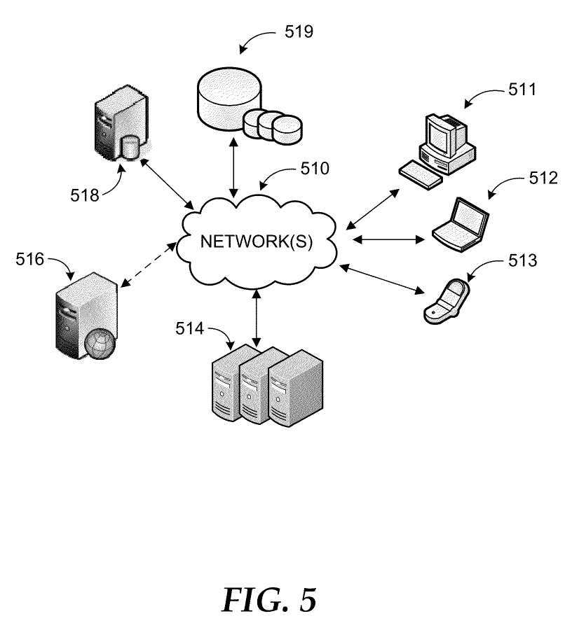

FIG. 5 is an example networked environment, where embodiments may be implemented. A system providing graphic display of data, including an animated graphic transition that may be displayed in conjunction with first and second graphic elements to represent a data difference, as described herein, may be implemented via software executed over one or more servers 514 such as a hosted service. The platform may communicate with client applications on individual computing devices such as a smart phone 513, a laptop computer 512, or desktop computer 511 ('client devices') through network(s) 510.

Client applications executed on any of the client devices 511-513 may facilitate communications via application(s) executed by servers 514, or on individual server 516. An application for graphically displaying data executed on one of the servers may facilitate selection of available options such as particular data sets or sources for such data sets. The application may provide information associated with options for displaying the graphic elements representing the data sets and the animated transition that represents the data difference between the data sets as discussed herein. The application for graphically displaying data may retrieve relevant data from data store(s) 519 directly or through database server 518, and provide requested services (e.g. document editing) to the user(s) through client devices 511-513.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a platform providing graphic display of data, including an animated graphic transition that may be displayed in conjunction with first and second graphic elements to represent a data difference, as described herein. Furthermore, the networked environments discussed in FIG. 5 are for illustration purposes only. Embodiments are not limited to the example applications, modules, or processes.

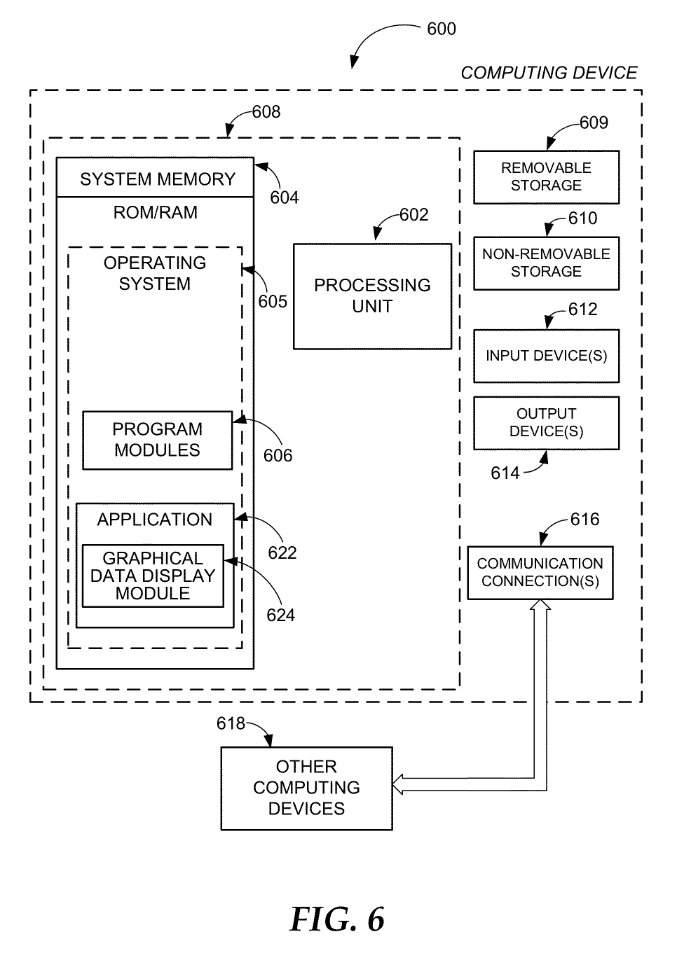

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any computing device executing an application capable of providing graphic display of data, including an animated graphic transition that may be displayed in conjunction with first and second graphic elements to represent a data difference, according to embodiments and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, example application 622, and graphic data display module 624.

Application 622 may enable users to define or select options for graphically displaying data, including an animated graphic transition that may be displayed in conjunction with first and second graphic elements to represent a data difference, as described herein. Through a user interface controlled by graphic data display module 624, application 622 may display information associated with selectable options including the plurality of data sets or other options associated with displaying the animated transition or the graphic elements corresponding to the data sets. Application 622 and graphic data display module 624 may be separate application or integrated modules of a hosted service. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

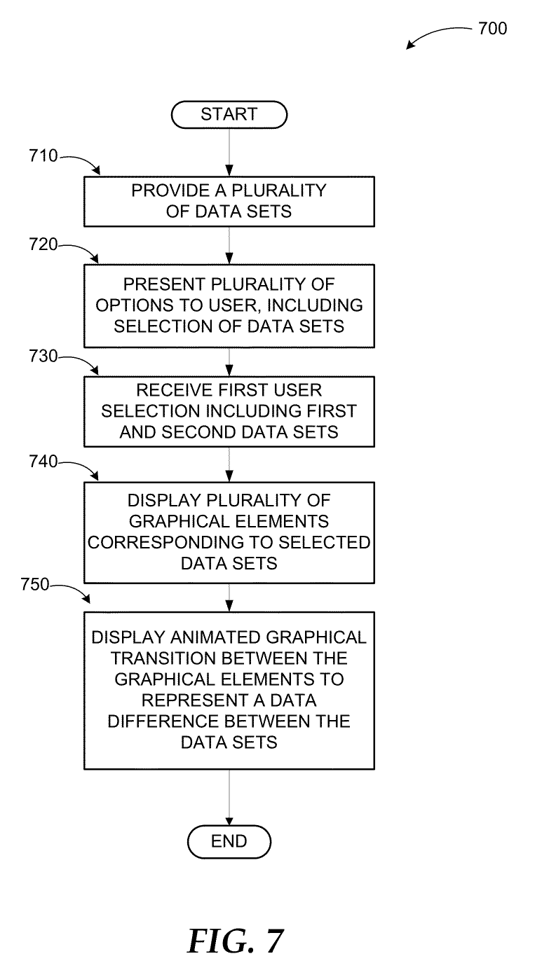

FIG. 7 illustrates a logic flow diagram for process 700 of providing graphic display of data, including an animated graphic transition that may be displayed in conjunction with first and second graphic elements to represent a data difference according to embodiments. Process 700 may be implemented on a server or other computing device.

Process 700 begins with operation 710, where a plurality of data sets is provided. The plurality of data sets may be provided, e.g., by user entry of data into a spreadsheet or database; by accessing data stored locally or in a network in a spreadsheet, database, text file, or other data storage format; by selecting a data feed, e.g., from a scientific instrument, a news service, a stock market data service; or the like.

At operation 720, a plurality of options is presented for selection by a user, including selection of a first data set and a second data set from the plurality of data sets. Operation 730 includes detecting a user selection from the plurality of options, including the first data set and the second data set. The user selection of the plurality of options can be determined by any suitable detection of user input, such as a user selection of data set from a range of data in a spreadsheet, or a user selection of a graphic or link associated with a data set such as checkbox, a selectable link, a drop-down menu, a radio button, or one of the plurality of graphic elements that represents data in one of the plurality of data sets. Thus, the options may be selected by the user by specifying textual, numerical, or graphic identifiers that correspond to the data sets, for example, icons of data set files in a storage medium, field codes that specify the location of the data sets in a database, names of data set files stored on a hard drive, and so on.

Operation 740 includes displaying a plurality of graphic elements, including a first graphic element that represents data in the first data set and a second graphic element that represents data in the second data set, according to embodiments. Operation 750 includes displaying a first animated graphic transition in conjunction with the first and second graphic elements to represent a data difference between the first and second data sets, according to embodiments.

The operations included in process 700 are for illustration purposes. Providing graphic display of data, including an animated graphic transition that may be displayed in conjunction with first and second graphic elements to represent a data difference may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for graphically displaying data, the method comprising:
providing a plurality of data sets;
presenting a plurality of options for selection by a user, including selection of one or more data sets from the plurality of data sets;
detecting a user selection from the plurality of options;
displaying a first graphic element that represents data in a first selected data set and a second graphic element that represents data in a second selected data set; and
displaying a first animated graphic transition in conjunction with the first and second graphic elements to represent a data difference between the selected data sets.

2. The method of claim 1, further comprising at least one from a set of:
enabling the user to select an existing presentation of the first and second graphic elements for displaying the first animated transition;
enabling the user to select a new presentation for displaying the first and second graphic elements and the first animated graphic transition; and
enabling the user to select an automatically recommended presentation for displaying the first and second graphic elements and the first animated graphic transition.

3. The method of claim 1, further comprising:
determining a third data set and a fourth data set from the user selection among the plurality of options;
displaying a third graphic element that represents data in the third data set and a fourth graphic element that represents data in the fourth data set; and
displaying a second animated graphic transition, wherein the second animated graphic transition is displayed in conjunction with the third and fourth graphic elements to represent a data difference between the third and fourth data sets.

4. The method of claim 3, wherein:
the third data set is different from the second data set, and
the fourth data set is one of: automatically determined to be the second data set and selected by the user from the plurality of data sets.

5. The method of claim 1, wherein displaying the first animated graphic transition includes animating at least one from a set of:
a transformation of the first graphic element into the second graphic element;
a graphic element that extends between the first and second graphic elements;
another graphic element that represents a direction of the data difference between the first and second graphic elements;
a change in a color of one or more of the graphic elements;
a change in a shade of one or more of the graphic elements; and
one of an appearance and a disappearance of one or more of the graphic elements.

6. The method of claim 5, wherein the other graphic element that represents the direction of the data difference between the first and second graphic elements includes at least one from a set of: a color gradient; a shade gradient; a perspective gradient; a symbolic directional indicator; a leading indicator; and a trailing indicator.

7. The method of claim 1, further comprising repeatedly displaying the first animated graphic transition.

8. The method of claim 7, wherein the plurality of options include one or more parameters for repeatedly displaying the first animated graphic transition.

9. The method of claim 1, further comprising at least one from a set of:
displaying a first sequence that includes the first graphic element, the first animated transition, and the second graphic element;
displaying a second sequence that includes the first graphic element, the first animated transition, the second graphic element, and a reversed sequence of the first animated transition;
repeatedly displaying one of the first sequence and the second sequence;
displaying one or more of the graphic elements prior to displaying the first animated transition;
displaying the first graphic element and the first graphic transition prior to displaying the second graphic element;
displaying the first animated transition and hiding one or more of the graphic elements; and
displaying the first animated transition and changing one of a color and a shade of one or more of the graphic elements.

10. The method of claim 1, further comprising detecting the user selection of one or more of the plurality of data sets based on one of an active selection and a pointer hovering over one of the plurality of graphic elements.

11. The method of claim 1, wherein the plurality of options are provided employing at least one from a set of: a checkbox, a selectable link, a drop-down menu, a radio button, and one of the plurality of graphic elements that represents data in one of the plurality of data sets.

12. A computing device for graphically displaying data, the computing device comprising:
a memory;
a processor coupled to the memory, the processor executing an application presenting a user interface for enabling a user to select a plurality of options, wherein the application is configured to:
provide a plurality of data sets;
present the plurality of options for selection by the user, including selection of a first data set and a second data set from the plurality of data sets;
detect a user selection from the plurality of options; and
upon detecting the user selection from the plurality of options:
display a plurality of graphic elements, including a first graphic element that represents data in the first data set and a second graphic element that represents data in the second data set; and
display a animated graphic transition, wherein the animated graphic transition is displayed in conjunction with the first and second graphic elements to represent a data difference between the first and second data sets.

13. The computing device of claim 12, wherein the user interface presents a graphic data presentation as one of: a graph, a chart, and a plot.

14. The computing device of claim 12, wherein the animated graphic transition includes display of a directional graphic element between the first and second graphic elements representing a direction of the data difference between the first and second graphic elements through at least one from a set of: a color gradient; a shade gradient; a perspective gradient; a symbolic directional indicator; a leading indicator; and a trailing indicator.

15. The computing device of claim 12, wherein the animated transition includes timed appearance and disappearance of the first graphic element followed by timed appearance and disappearance of a plurality of intermediate graphic elements followed by timed appearance of the second graphic element.

16. The computing device of claim 12, wherein the computing device is a server and the application is a web application presenting the user interface to the user through a browsing application executed on a client computing device.

17. A computer-readable storage medium with instructions stored thereon for graphically displaying data, the instructions comprising:
providing a plurality of data sets;
presenting a plurality of options for selection by a user, including selection of a one or more data sets from the plurality of data sets;
detecting a user selection from the plurality of options;
displaying a plurality of graphic elements representing data in the selected one or more data sets; and
displaying an animated graphic transition in conjunction with the plurality of graphic elements to represent a data difference between the selected one or more data sets, wherein the animated graphic transition includes at least one from a set of: a plurality of intermediate graphic elements temporarily displayed between the plurality of graphic elements and one or more directional graphic elements indicating a direction of data change between the plurality of graphic elements.

18. The computer-readable storage medium of claim 17, wherein the plurality of graphic elements comprise of data points represented by one or more of a text, a symbol, a graphic icon, a bar, a pie slice, a vertex, and an inflection in connectors between data points; and wherein the data points are connected by one or more of lines and curves.

19. The computer-readable storage medium of claim 17, wherein the instructions for displaying the animated graphic transition further comprise animating at least one from a set of:
a transformation of one of the plurality of graphic elements into another graphic element;
a directional graphic element that extends between the plurality of graphic elements;
a change in a color of one or more of the plurality of graphic elements;
a change in a shade of one or more of the plurality of graphic elements; and
one of an appearance and a disappearance of one or more of the plurality of graphic elements.

20. The computer-readable storage medium of claim 17, wherein the instructions further comprise at least one from the set of:
displaying a first sequence that includes at least two of the plurality of graphic elements and the animated transition;
displaying a second sequence that includes the at least two of the plurality of graphic elements, the animated transition, and a reversed sequence of the animated transition;
repeatedly displaying one of the first sequence and the second sequence;
displaying one or more of the plurality of graphic elements prior to displaying the animated transition;
displaying the animated transition and hiding one or more of the plurality of graphic elements; and
displaying the animated transition and changing one of a color and a shade of one or more of the plurality of graphic elements.
